(19) United States
(12) Patent Application Publication
(10) Pub. No.: US 2011/0108358 A1
(43) Pub. Date: May 12, 2011

(54) NOISE ATTENUATOR AND RESONATOR

(76) Inventors: Jason Michael Edgington, Cedar Falls, IA (US); Bryan Kirk Buerkle, Cedar Falls, IA (US); Jeffrey John Girard, Cedar Falls, IA (US); Jeffery Kahle Brown, Dike, IA (US)

(21) Appl. No.: 12/613,877

(22) Filed: Nov. 6, 2009

(51) Int. Cl. F02M 35/12

(52) U.S. Cl. 181/229

(57) ABSTRACT

A resonator attenuates sound waves at first and second frequencies. The resonator includes a first tube, and a second tube received within the first tube. Both tubes have an open end and a closed end. The first tube has an axial length which is longer than the axial length of the second tube. The first tube attenuates sound waves at the first frequency and the second tube attenuates sound waves at the second frequency. The second tube has an outer wall which engages an inner wall of the first tube. The open end of the second tube is surrounded by the open end of the first tube. The open end of the first tube is attached to an engine air intake conduit. The conduit communicates air from a charge air cooler to an engine intake manifold.

### FIELD OF THE INVENTION

The present invention relates to a resonator for reducing noise generated by the air intake system of an internal combustion engine.

### BACKGROUND OF THE INVENTION

The operation of a vehicle engine causes pressure waves to propagate through the air induction system. These pressure waves exit the intake air filter box, generating noise which is transmitted to the operator's ear. This noise is a significant contributor to the overall sound level heard by the operator. The resultant noise is comprised mainly of low frequency noise which is at a frequency that is too low to be attenuated by common techniques and methods such as acoustical foam.

A number prior art attempts have been made to reduce such noise generated by a combustion engine used in automotive and other applications. Existing devices which have capability to attenuate multiple frequencies utilize multiple, separate resonator tubes, multiple tubes connected to a common inlet, or single tubes with chambers separated by a wall with a hole in it.

Known conventional apparatus for attenuating multiple frequency sound waves are typically expensive and complex and are comprised of multiple component parts such as valves or flappers. Others require separate branches for each frequency sound wave attenuated. Such known devices for attenuating multiple frequencies are bulky and do not easily fit in the limited space of a refrigeration unit.

For example, U.S. Pat. No. 5,996,733 shows a unitary dual frequency side branch resonator having an inlet branch, a discharge branch, and a resonator branch with attenuating means for attenuating sound waves at a first frequency located in the resonator branch and a resonator branch closed end downstream of the attenuating means for attenuating sound waves at a second frequency.

U.S. Pat. No. 5,349,141 shows a resonator type silencer installed in an intake system of an automotive internal combustion engine. The resonator type silencer comprises a generally cup-shaped base member integrally connected with an air duct through which intake air to be inducted into the engine passes.

U.S. Pat. No. 6,814,041 shows a multi-frequency engine intake resonator which has a pair of molded sheets mated to each other along a plane and defining a plurality of tubular channels therebetween and having different length for attenuation of different frequencies.

U.S. Pat. No. 6,009,705 shows a noise attenuator for an induction system or an exhaust system. This system includes a quarter wave resonator tube inside a housing which opens on to a first gas flow passage. The noise attenuator can be installed as a single integrated unit in the induction system or the exhaust system.

It is desired to have a noise attenuator which is compact, which can attenuate two frequencies and which can withstand pressures and temperatures in engine charge air system. Reducing the noise generated by the air induction system would help meet noise regulations in various countries.

### SUMMARY OF THE INVENTION

Accordingly, an object of this invention is to provide a compact system for attenuating noise generated by an engine air intake system.

A further object of the invention is to provide such a system which attenuates noise at different frequencies.

These and other objects are achieved by the present invention, wherein a side branch resonator is affixed to an intake air conduit in the engine combustion air induction system. The resonator includes an outer pipe which extends from an open inlet to a closed end. One or more inner pipes are contained within the outer pipe. Each inner pipe shares a common open end with the outer pipe, but has its own closed end. The length of each pipe is determined by the desired frequency tuning of the resonator. The resonator acts to significantly reduce the noise radiated by the engine combustion air induction system.

### BRIEF DESCRIPTION OF THE DRAWINGS

FIG. 1 is a perspective view of an engine assembly embodying the invention; and

FIG. 2 is a partially sectional side view of the noise attenuator of FIG. 1;

FIG. 3 is a sectional view along lines 3-3 of FIG. 2;

FIG. 4 is a partially sectional side view of an alternate embodiment of the noise attenuator of FIG. 1;

FIG. 5 is a sectional view along lines 5-5 of FIG. 4;

FIG. 6 is a partially sectional side view of another embodiment of the noise attenuator of FIG. 1; and

FIG. 7 is a sectional view along lines 7-7 of FIG. 6.

### DESCRIPTION OF THE PREFERRED EMBODIMENT

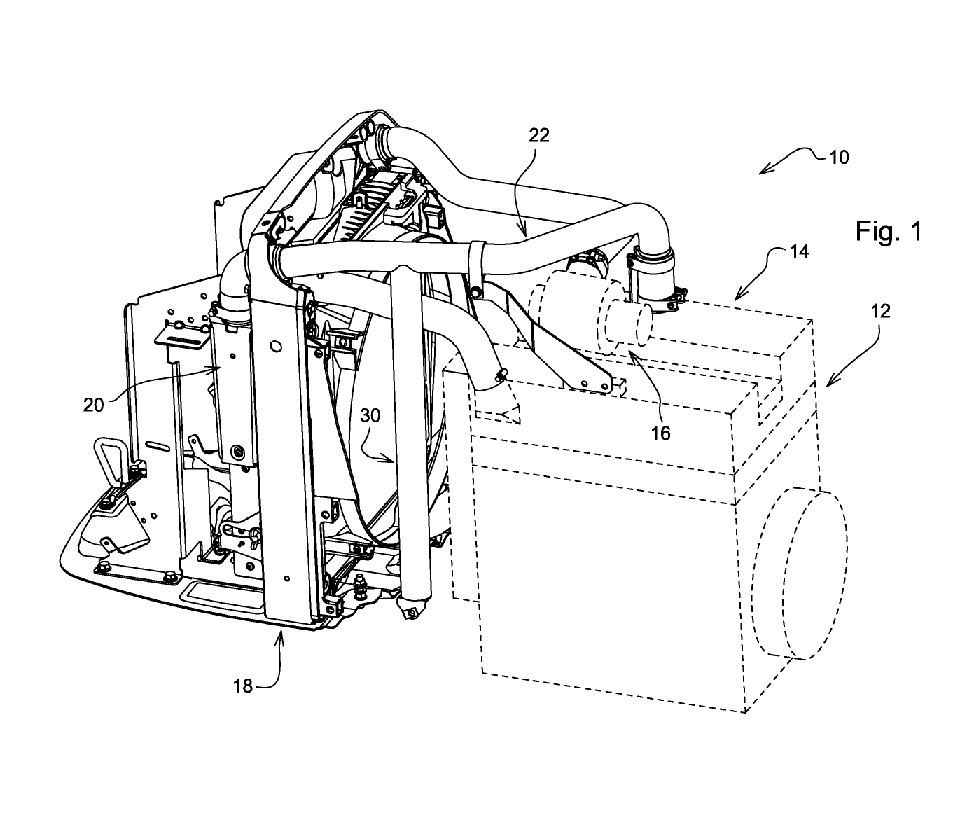

Referring to FIG. 1, a vehicle engine assembly 10 includes an engine 12 which has an intake manifold 14 and a turbo-compressor 16. Located in front of the engine 12 is a radiator 18 and a charge air cooler 20. A conduit 22 communicates cooled intake charge air from the charge air cooler 20 to the intake manifold 14.

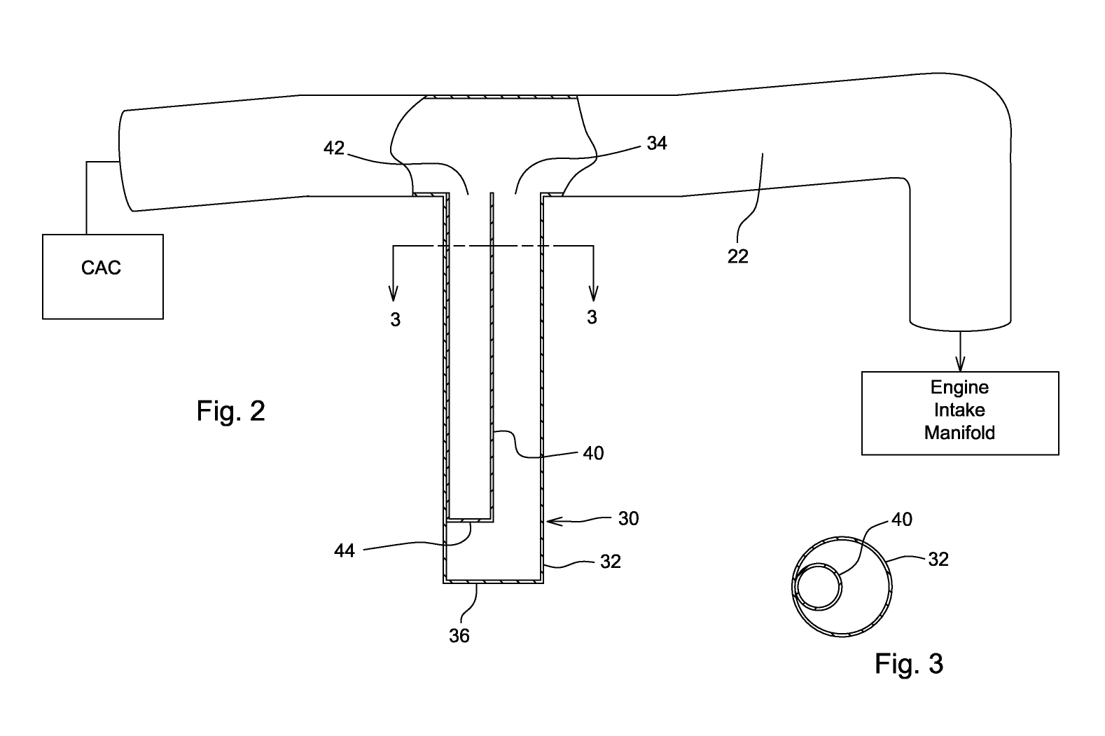

A noise attenuator 30 is connected to a mid portion of the conduit 22. As best seen in FIGS. 2 and 3, the noise attenuator 30 includes a first or outer cylindrical tube 32 with an open end 34 and a closed end 36. A second or inner cylindrical tube 40 is received within the outer tube 32. A wall of inner tube 40 engages an inner surface of a wall of outer tube 32. Inner tube 40 has an open end 42 and a closed end 44, and is shorter than outer tube 32. The diameter and lengths of tubes 32 and 40 are chosen so as to attenuate noise at two different desired noise frequencies.

The inner tube 40 is preferably welded to the outer tube 32 using a few plug welds (not shown), but other attachment methods could be used. Both tubes may be made from steel with anodized aluminum coating. However, other materials could be used, such as plastic, for example.

The result is a side-branch resonator which reduces noise radiated from the tractor engine combustion air induction system. The resonator includes two tubes, one inside the other, each having a certain length tuned to a specific frequency. The resonator assembly attenuates two frequencies while occupying the packaging space of a single-frequency device.

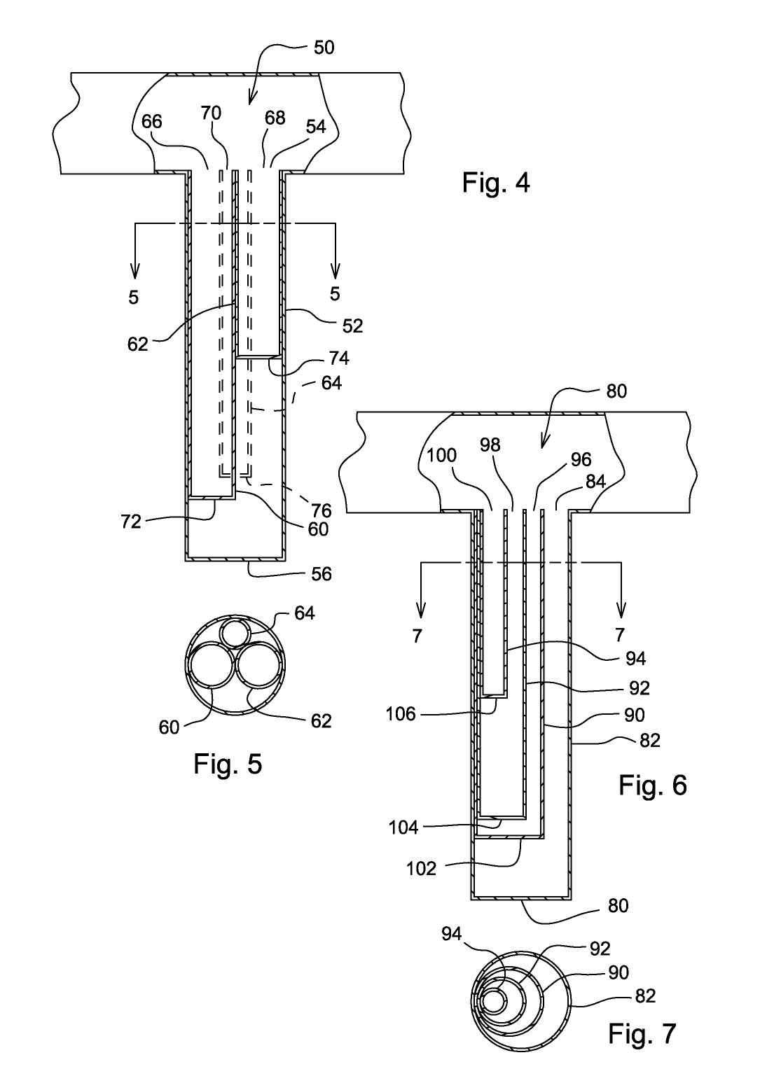

Referring now to FIGS. 4 and 5, the noise attenuator 50 includes a first or outer cylindrical tube 52 with an open end 54 and a closed end 56. A plurality of inner cylindrical tubes 60, 62 and 64 are received within the outer tube 52. The walls of inner tubes 60-64 engage an inner surface of a wall of outer tube 52. Each inner tube 60-64 has a corresponding open end 66, 68 and 70 and a closed end 72, 74 and 76, and is shorter than outer tube 52. The diameter and lengths of tubes 52 and 60-64 are chosen so as to attenuate noise at a plurality of different desired noise frequencies.

Referring now to FIGS. 6 and 7, the noise attenuator 80 includes a first or outer cylindrical tube 82 with an open end 84 and a closed end 86. A plurality of inner cylindrical tubes 90, 92 and 94 are received or nested concentrically within the outer tube 82. A wall of the inner tube 94 engages an inner surface of a wall of the surrounding tube 92. A wall of the inner tube 92 engages an inner surface of a wall of the surrounding tube 90. A wall of the inner tube 90 engages an inner surface of a wall of the surrounding outer tube 82.

Each inner tube 90-94 has a corresponding open end 96, 98 and 100 and a closed end 102, 104 and 106, and is shorter than outer tube 82. The diameter and lengths of tubes 82 and 90-94 are chosen so as to attenuate noise at a plurality of different desired noise frequencies.

While the present invention has been described in conjunction with a specific embodiment, it is understood that many alternatives, modifications and variations will be apparent to those skilled in the art in light of the foregoing description. For example, the concept of the present invention could also apply to tubes which are other than cylindrical in shape. Accordingly, this invention is intended to embrace all such alternatives, modifications and variations which fall within the spirit and scope of the appended claims.

1. A resonator for attenuating sound waves at first and second frequencies, the resonator comprising:
a first tube with an open end and a closed end; and
at least a second tube received within the first tube, the second tube having an open end and a closed end, and the first tube having a first axial length which is longer than a second axial length of the second tube, the first tube attenuating sound waves at the first frequency and the second tube attenuating sound waves at the second frequency, the open end of the second tube being surrounded by and aligned with the open end of the first tube.

2. The resonator of claim 1, wherein:
the second tube has an outer wall which engages an inner wall of the first tube.

3. (canceled)

4. The resonator of claim 1, wherein:
the open end of the first tube is attached to an engine air intake conduit

5. The resonator of claim 1, wherein:
the open end of the first tube is attached to an engine air intake conduit which communicates air from a charge air cooler to an engine intake manifold.

6. The resonator of claim 1, wherein:
the outer walls of the first and second tubes are cylindrical.

7. In an engine air intake having an air conduit for communicating intake air from a charge air cooler to an intake manifold, a sound attenuator comprising:
a first tube attached to a mid-portion of the conduit, the first tube having an open end and a closed end, the open end being in communication with an interior of the conduit; and
a second tube received within the first tube, the second tube having an open end and a closed end, the second tube having an outer wall which engages an outer wall of the first tube, and the first tube having a first axial length which is longer than a second axial length of the second tube, the first tube attenuating sound waves at the first frequency and the second tube attenuating sound waves at the second frequency, the open end of the second tube being surrounded by and aligned with the open end of the first tube, and both open ends being substantially aligned with a surface of the conduit.

8. (canceled)

9. (canceled)

10. The resonator of claim 7, wherein:
the outer walls of the first and second tubes are cylindrical.

11. (canceled)

12. A resonator for attenuating sound waves at a plurality of frequencies, the resonator comprising:
an outer tube with an open end and a closed end; and
a plurality of pipes received within the tube, each pipe having an open end and a closed end, and each pipe having an axial length which is different from an axial length of the tube and an axial length of the other pipes, the tube attenuating sound waves at a selected frequency and each pipe attenuating sound waves at a chosen frequency which is different from the selected frequency, the open end of the pipes being surrounded by and aligned with the open end of the tube.

13. The resonator of claim 12, wherein:
the plurality of pipes are nested within each other.

14. The resonator of claim 12, wherein:
at least one of the pipes is received within another of the of pipes.

15. The resonator of claim 12, wherein:
each of the plurality of pipes is positioned adjacent to at least one of the other pipes.

16. In an engine air intake having an air conduit for communicating intake air from a charge air cooler to an intake manifold, a sound attenuator comprising:
a first cylindrical tube attached to a mid-portion of the conduit, the first tube having an open end and a closed end, the open end being in communication with an interior of the conduit, the first tube having a first longitudinal axis which is substantially perpendicular to a direction of air flow through the conduit; and
a second cylindrical tube received within the first tube, the second tube having an open end and a closed end, the second tube having an outer wall which engages an outer wall of the first tube, and the first tube having a first axial length which is longer than a second axial length of the second tube, the second tube having a second longitudinal axis which is substantially perpendicular to a direction of air flow through the conduit, the first tube attenuating sound waves at the first frequency and the second tube attenuating sound waves at the second frequency, the open end of the second tube being aligned with the open end of the first tube, and both open ends being substantially aligned with a surface of the conduit.
